(19) United States
(12) Patent Application Publication
(10) Pub. No.: US 2014/0052526 A1
(43) Pub. Date: Feb. 20, 2014

(54) SYSTEM AND METHOD FOR GOAL BASED SAVINGS

(71) Applicant: Terence J. CULLEN, Southampton, NY (US)

(72) Inventor: Terence J. CULLEN, Southampton, NY (US)

(21) Appl. No.: 14/067,461

(22) Filed: Oct. 30, 2013

Related U.S. Application Data
(63) Continuation-in-part of application No. 13/536,269, filed on Jun. 28, 2012.
(60) Provisional application No. 61/501,971, filed on Jun. 28, 2011.
(60) Provisional application No. 61/533,567, filed on Sep. 12, 2011.

(51) Int. Cl. G06Q 50/20; G06Q 30/02

(52) U.S. Cl. CPC G06Q 50/20; G06Q 30/0233
USPC 705/14.33

(57) ABSTRACT

A method, performed by a server, for incentivizing school performance includes receiving score information corresponding to a student from a first user terminal and adding score information to a student profile corresponding to the student in a database. A credit adjustment value is calculated based on the received score information and a new total number of credits stored in the student profile is set to a sum of the credit adjustment value and a total number of credits previously stored in the student profile. A request for merchant offer information corresponding to the student profile is received from a second user terminal. For at least one merchant, a respective merchant offer is generated according to at least a portion of the total number of credits set in the student profile and information corresponding to the merchant.

### PRIORITY

This application is a continuation in part of U.S. application Ser. No. 13/536,269, filed with the U.S. Patent and Trademark Office on Jun. 28, 2012, which claims priority to U.S. Provisional Applications No. 61/501,971 and 61/533,567, filed with the U.S. Patent and Trademark Office on Jun. 28, 2011 and Sep. 12, 2011, respectively, the entire content of each of which is incorporated herein by reference.

### BACKGROUND OF THE INVENTION

1. Field of the Invention

The present invention relates generally to goal based savings, and more particularly, to a system and method for improving performance by providing milestone incentives.

2. Description of the Related Art

Students often daydream about purchasing expensive items such as a cell phone or a car, the purchase of which is typically the students' first major purchase. Such students are often high school students who spend significant time fixated on these expensive items, often to the neglect of schoolwork, resulting in low academic performance, to the dismay of the students' parents.

Some school districts seek to address this problem by paying students who obtain good grades. Others school districts pay students to attend after-school study programs. See Gregg Toppo, Good Grades Pay off Literally, USA Today, Jan. 27, 2008. (http://www.usatoday.com/news/education/2008-01-27-grades_N.htm). However, payments provided by such conventional systems are typically provided as periodic cash payments directly to the student or parent, and are not correlated to the purchase of any specific item, such as a car, a cell phone, or even payment for college. Such conventional systems also fail to provide long-term motivation to those students who are most at risk of low academic performance.

### SUMMARY OF THE INVENTION

Accordingly, aspects of the present invention address the above problems and disadvantages and provide the advantages described below. An aspect of the present invention provides a method, performed by a server, for incentivizing performance. The method includes receiving score information corresponding to a performer from a first user terminal; adding the score information to a profile corresponding to the performer in a database; calculating a credit adjustment value based on the received score information; setting a new total number of credits stored in the performer profile to a sum of the credit adjustment value and a total number of credits previously stored in the performer profile; receiving, from a second user terminal, a request for merchant offer information corresponding to the performer profile; generating, for at least one merchant, a respective merchant offer according to at least a portion of the total number of credits set in the performer profile and information corresponding to the merchant; and transmitting, in response to the request from the second user terminal, the at least one generated merchant offer.

An aspect of the invention provides a method for incentivizing school performance. The method includes storing a database on a memory and accessing the database through an Internet portal via an Internet connection. The method includes inputting enrollment information and financial information of a student into a student profile accessed through the Internet portal and displaying the enrollment information on a display. The method includes inputting at least one of scores, attendance and credit card payment data into the student profile, storing the student profile on the database and adding credits to an account associated with the profile based on one of the scores, attendance and credit card payment data.

### BRIEF DESCRIPTION OF THE DRAWINGS

The above and other aspects, features and advantages of certain embodiments of the present invention will be more apparent from the following detailed description taken in conjunction with the accompanying drawings, in which:

FIG. 1 is a diagram illustrating a system having a first user terminal and a second user terminal connected by an Internet connection, according to an embodiment of the present invention;

FIG. 2 is a flow-chart illustrating a method for incentivizing student performance, according to an embodiment of the present invention;

FIG. 3 is a diagram illustrating a system including a terminal and a mobile terminal, according to an embodiment of the present invention; and

FIG. 4 is a flow-chart illustrating a system and method, performed by a server, for incentivizing school performance, according to an embodiment of the present invention.

### DETAILED DESCRIPTION OF EMBODIMENTS OF THE PRESENT INVENTION

The following detailed description of certain embodiments of the present invention will be made in reference to the accompanying drawings. In describing the invention, explanation about related functions or constructions known in the art are omitted for the sake of clarity in understanding the concept of the invention, to avoid obscuring the invention with unnecessary detail.

According to embodiments of the present invention, a system and method incentivizes a student's school performance, both academically and socially, by providing milestone additions to savings. The savings can be used to pay for items such as a car or clothing, as well as payment for insurance, cell phones, college tuition etc. In addition, the present invention provides a system and method to obtain discounts from businesses based on the student's grades.

Embodiments of the present invention provide a system and method to motivate the student with quantifiable steps towards achieving the goal of purchasing items the student otherwise might be unaware of or unable to afford.

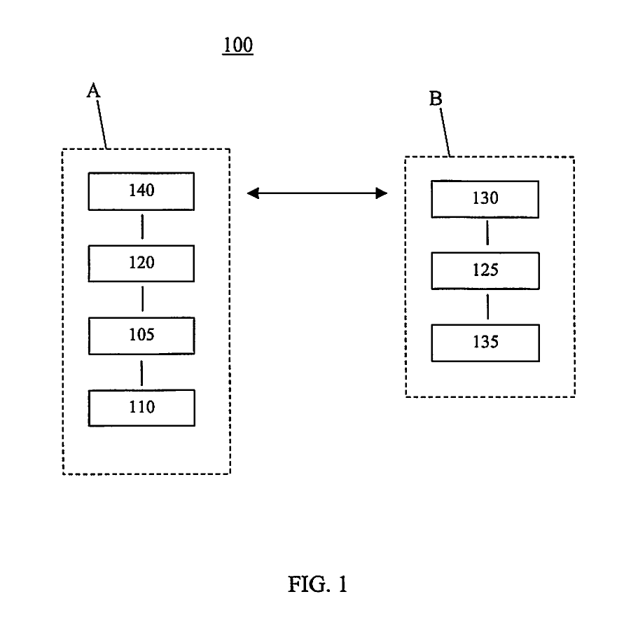

Referring to FIG. 1, FIG. 1 illustrates a system having a first user terminal and a second user terminal connected by an Internet connection according to an embodiment of the present invention. The first and second user terminals include a computer, a server, a network, a cell phone, a tablet, a Personal Digital Assistant (PDA), and a Motion Picture Experts Group Audio Layer-3 (MP3) player. Specifically, FIG. 1 illustrates a system 100 for incentivizing student performance including a first terminal A and a second terminal B. The first terminal A includes a memory 105, a database 110, a first processor 120 and an Internet portal 140. The second terminal B includes a second processor 125, a display 130, and an input unit 135. The input unit 135 includes a keyboard, a touchscreen, etc., and may be part of the display 130 if the input unit 135 is a touchscreen. The memory 105 stores information for the first processor 120, such as the database 110, and is controlled by the first processor 120. The system 100 transmits information between the first terminal A and the second terminal B through the Internet portal 140 over an Internet connection. The Internet portal 140 is preferably a website. The Internet connection preferably includes a server maintained by an Internet provider.

According to an embodiment of the present invention, the first terminal A is controlled by an organization. The organization is a business that maintains the Internet portal 140 and the database 110. The organization may charge fees for use of the Internet portal 140. Alternatively, the organization may obtain revenue from advertisements listed on the Internet portal 140.

Student information is input into the database 110. Authorized users use the input unit 135 to input the information, such as enrollment information, using the Internet portal 140. Specifically, the second processor 125 transmits the information over the Internet connection through the Internet portal 140 to the first processor 120, which stores the information in the database 110 on the memory 105. Users authorized to input student information, such as enrollment information, student grades, attendance information, etc., to the database 110 may be restricted to include any one of, or a combination of, students, teachers, school administrators, registered parents and/or guardians, etc., or any combination thereof. Authorization may be performed through a password entry system, for example, but other authorization methods may be used in accordance with embodiments of the present invention.

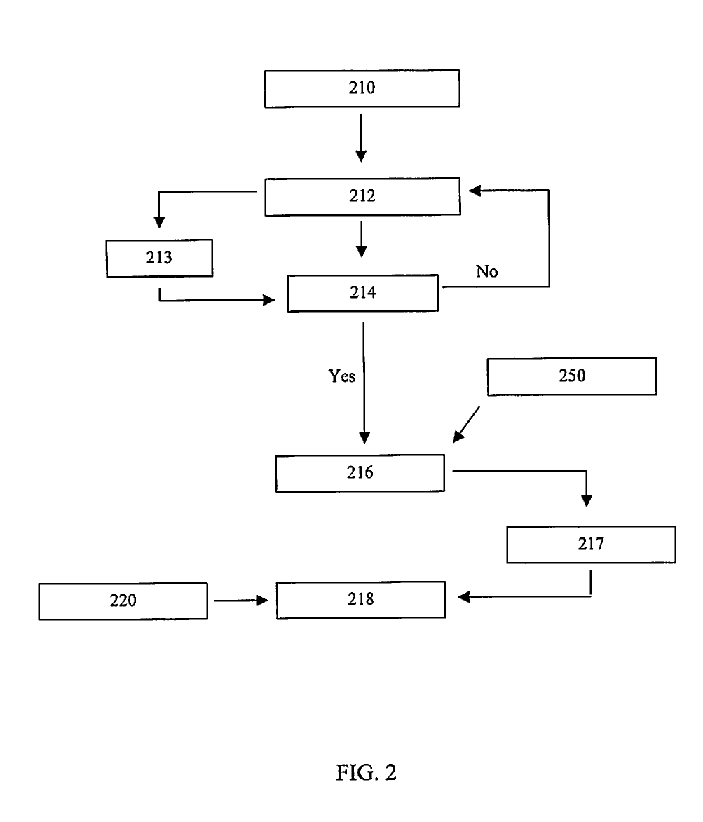

Referring now to FIG. 2, FIG. 2 is a flow-chart illustrating a method for incentivizing student performance according to an embodiment of the present invention. The method includes storing a database on a memory and accessing the database through an Internet portal via an Internet connection.

In step 210, a plurality of students and a plurality of contributors enroll with the organization. The enrollment facilitates creation of a student profile and a contributor profile, respectively. Enrollment of the students and the contributors is preferably performed on the Internet, as known by those of skill in the art, via the Internet portal 140. The contributors would, among others, preferably include a school, an educational institution, a parent, a governmental entity, a merchant and a business. The students and the contributors access the Internet portal 140 through the second terminal B. Specifically, the second terminal B is provided as an example of how the students and the contributors access the Internet portal 140. Thus, according to an embodiment of the present invention, the system 100 includes a plurality of terminals that the students and the contributors use to access the Internet portal 140.

The contributors may be required to have a subscription with the organization to use the Internet portal 140. That is, the subscribing contributors may be required to pay a fee to obtain access to the Internet portal 140. Upon paying the fee, the contributors preferably receive a password to access the Internet portal 140. The Internet portal 140 allows the students and the contributors to access the database 110.

According to an embodiment of the present invention, the students and the contributors access the Internet portal 140. The students and the contributors input enrollment information into the Internet portal 140 using the input unit 135. The enrollment information is transmitted using the second processor 125 over the Internet connection to the Internet portal 140 and is stored in the database 110 on the memory 105. The students and the contributors view the enrollment information stored in the database 110 on the display 130 when the students and the contributors access the Internet portal 140. Authorization to view or edit information in the database 110 may vary for each respective student and contributor. For example, according to an embodiment of the present invention, certain contributors cannot access the students' enrollment information without prior permission from the students.

The database 110 stores a unique identifier for each of the students and the contributors. Specifically, when the students and the contributors enroll, they each receive their own unique identifier, with the database 110 maintaining affiliations between the identifiers of the related students, school(s) and parent(s) etc. The unique identifier includes a user name, a password, a number code, etc., to identify the students and the contributors. Thus, the unique identifier may be required for the students and the contributors to access the Internet portal 140 to verify the students' and the contributors' identity. The students' identifier tracks an amount of “funds” that are adjusted according to student information, such as grades, attendance information, etc. added to the students' profile in the database 110. For example, the amount of funds in the student profile may be set to increase when the student's grades exceed a predetermined threshold, as described below in regards to step 214. As further described below, the funds include credits and real money, such as US dollars.

According to an embodiment of the present invention, the parent(s) establish a link to a parent bank account or credit line that is authorized to transfer real money from an affiliated financial institution, as described below at step 220. Accordingly, parent(s) and other family members, including friends and members of a student's extended family, or other authorized entities, are provided in step 220 an option of contributing additional money to a student's profile, to further incentivize good performance in school.

For example, according to an embodiment of the present invention, parent contribution can be based on the student information satisfying certain requirements, such as student grades exceeding certain thresholds, as described above in regards to steps 212-216, with or without limits on contribution since the real money is in addition to the funds that are ‘paid’ in step 250, as discussed below. In such an embodiment, the real money is maintained in a subscribing financial institution.

In step 212 of FIG. 2, report card grades, also referred to as ‘scores’ and ‘score information’ herein, are input into the database 110 through the Internet portal 140. While the scores can be directly input by the student, subject to verification, such as by the parent or school, an embodiment of the present invention requires receipt of scores from the subscribing school, to simplify verification of same. That is, the subscribing school transmits the scores through the Internet portal 140 to be input into the database 110. The scores are associated with each student's grades based on the student's unique identifier.

According to an embodiment of the present invention, in step 213, if the student inputs the scores on his/her own, the school verifies the scores input into the database 110 by the student. Specifically, the verification step 213 includes the subscribing school sending the student an access code or individual access link. In the case of the access code, the student may input the access code into the Internet portal 140 to upload verified scores transmitted from the subscribing school into the database 110. Alternatively, the subscribing school may send the student the individual access link, i.e. an individual URL, which will link the student's verified grades to the database 110.

In step 214, the scores, or an aggregate of individual scores thereof, are compared to the predetermined threshold. If the score meets or exceeds the threshold, an increase is made in step 216 to a sub-total of funds attributed to the student. The individual scores include results of national and state tests, such as SAT, ACT and State Regents Examinations, semester report card grades, and individual tests and assignments. Specifically, the individual scores are, for example, results of a test given in a specific subject area, such as mathematics or science. Thus, the contributors can incentivize higher grades on a specific test or a specific assignment, such as a national science test, etc.

Additionally, the sub-total funds are not real money. Rather, the sub-total funds are credits that can be applied to purchase, or reduce the price of, items for sale from the businesses subscribing to the organization. For example, an “A” grade may provide 10 credits in sub-total funds, a “B” grade may provide 5 credits in sub-total funds, a “C” grade may provide 2.50 credits in sub-total funds, and, as further examples, 25 credits in sub-total funds will be provided for perfect attendance, participation in athletics or other school-related activities, community volunteer work, completion of surveys, or other requirements. According to an embodiment of the present invention, a maximum accumulation of sub-total funds is established, such as, 150 credits maximum per year for an ‘A’ student.

According to an embodiment of the present invention, the sub-total of funds represents the student's overall academic and personal achievement and may be used to gauge the student's likely success in college, employment and military service similar to a FICO score generated by credit agencies.

In step 217, the sub-total funds are converted to a real money value and added to the real money to provide total funds at step 218. Preferably, the total funds are available on the Internet via the Internet portal 140. The Internet portal 140 can, alternatively, show a reduction in price for individual items available for purchase from the contributors, such as a vehicle or cost of tuition made available through the Internet portal 140.

At step 218 of FIG. 2, the student is preferably provided with separate totals of the sub-total funds that the student has earned as well as the contributed real money. Additionally, as described further with respect to Table 1 below, a total amount of funds for each of the contributors can be provided. The total amount of funds informs the student how much real money the student may spend with each contributor based on the contributor's individual conversion rate.

According to an embodiment of the present invention, the student can use the total funds at any business or institution subscribing to the organization's Internet portal 140. For example, the student may access links on the Internet portal 140 to the subscribing businesses websites and purchase items on the businesses websites using the total funds. An individual conversion rate, described below, informs the student of the real monetary value of the sub-total funds for purchasing items from the business. The business preferably provides a discount coupon or its own brand of money for purchase of the items. The total funds can be used to pay for any item desired by the student that is offered by the contributors subscribing to the organization. The first terminal A determines how many credits are converted with respect to each business according to a conversion rate set for each business based upon business profile information stored in the database 110, and/or the terminal A may request updated conversion rate information from businesses upon receiving a request from a student, for example, requesting information on redemption value of the credits in the student's profile for each business.

For example, if a student has 850 credits of sub-total funds in their account for obtaining certain grades, a clothing retailer may provide a credit for shopping at their store. Specifically, the student may access the Internet portal 140 to determine an amount of money the clothing retailer will provide for the students' 850 credits based on the clothing retailer's conversion rate. The conversion rate may vary between businesses. If the clothing retailer provides a 20% conversion rate, the student would have $170 to spend at the clothing retailer. Accordingly, the Internet portal 140 provides a vehicle for businesses to market to the students.

In an embodiment of the present invention, the Internet portal 140 is used to redeem the funds for purchase of more practical items, such as a car. The car is preferably purchased on a clearinghouse basis from any participating car dealer who has the model/type of car desired by the student, and the student will purchase the car via the Internet portal 140 without knowing which specific dealer actually provided the purchased car.

To enhance student and parent acceptance, all cars would be Kelley Blue Book™/Edmunds™ certified/appraised, and a warranty accompanies each purchase. Availability of a universal warranty provides a significant incentive to increase parent participation, with parents wanting the first car owned by their children to be a reliable, safe car, backed by a reliable insurer.

Table 1 illustrates a hypothetical student's available sub-total funds and total funds along with hypothetical conversion rates offered by the contributors. Specifically, the student's Parent has deposited $200 of real money into the student's account. The student has obtained five (5) “A” grades. In this example, each “A” grade is valued by the parent at $40 of real money, which may be automatically transferred to the student's account, as described above regarding step 220. The contributors have set each “A” grade as being worth 100 credits, though the value of grades can be adjusted by each of the contributors.

As illustrated in Table 1, the clothing retailer, car dealership and college all offer their own conversion rate for how much real money each credit is worth. The amount of real money ($200) in this example may be added to an amount of sub-total funds offered by the contributors to provide the student with total available funds to use to make purchases through the Internet portal 140. Thus, according to Table 1, the student has $450 to make purchases at the clothing retailer.

TABLE 1

| | | Credits/ | Conver- | Sub- | Total |
|---|---|---|---|---|---|
| | | Real Money | sion | Total | Funds |
| Contributor | Grades | ($) | Rate | Funds | ($) |
| Parent | A (5) | 200 | N/A | N/A | 200 |
| Clothing Retailer | A (5) | 500 | 50% | 250 | 450 |
| Car Dealership | A (5) | 500 | 60% | 300 | 500 |
| College | A (5) | 500 | 80% | 400 | 600 |

In another embodiment, the increase or ‘payment’ made to the sub-total funds is provided by a limited contributor in step 250, such as a subscribing car dealership or college in which an associated restriction on use of the contributed funds is provided. That is, funds provided from the limited contributor may only be used to purchase items in a manner specified by the limited contributor. For example, the restriction may be to a certain time period or on certain items available for purchase. The increase in the sub-total funds to the account preferably occurs automatically upon reaching the predetermined threshold.

In another embodiment, the limited contributor includes a group of subscribing limited contributors, who each contribute a percentage of each increase in sub-total funds, and each contribute toward the reduction in the price of items available for purchase. The item is then purchased from among the group of subscribing limited contributors.

In a further embodiment, the database 110 is maintained by an organization that solicits nationwide participation among students, parents and schools. The organization allows businesses to submit bids to obtain access to the information in database 110, with the bidding dealers providing price reductions, which will typically not exceed profit margin, equivalent to each student's accumulated funds.

In an embodiment of the present invention, the student can elect to spend a higher amount of accumulated funds to obtain an exact item, such as a car, desired by the student. According to a particular embodiment, some or most car models are purchased on a clearinghouse basis from any one of a number of participating car dealers, and the purchasing student may or may not know which specific dealer provided the car.

Profits to the organization are available from one or more of:
student membership fees, which can be credited at the time the student opens the account as an incentive to open a new account;
business membership fees;
payment of a percentage of the price or profit for each item sold to a participating student;
car financing, such as by affiliation with a national lender;
advertising on the Internet portal 140;
direct participation by car dealers;
direct participation by auto insurance brokers;
payment of a percentage of car shipping, i.e. trucking, fees, considering that purchase via the Internet portal 140 can involve a nationwide network of dealers and associated fees for shipping of the purchased car;
dealer profits from extra advertising, such as a deal of the week format; and
tuition, including purchase of college credits.

In regards to the purchase of cars, sales teams can visit high school and college events, tapping into the huge demographic of potential first time buyers, most of whom will elect to purchase a used car, which typically provides a higher profit to the car dealer. However, the student may opt to attend college courses using the funds to pay for college tuition. Subscribing colleges would therefore be able to provide focused marketing efforts to potential students, thereby reducing advertising costs paid by colleges. Auto insurers will also pay a higher amount to participate in this program, in view of the nationwide exposure to new customers and the higher insurance premiums paid by high school and college age drivers.

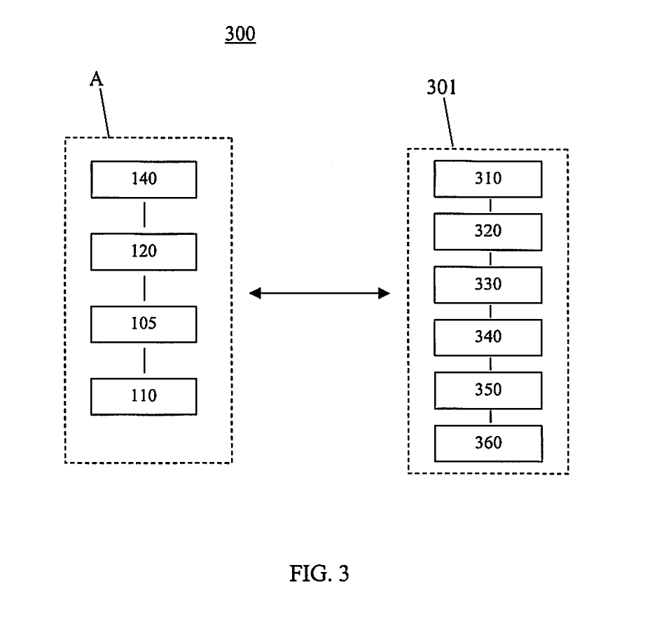

Referring now to FIG. 3, FIG. 3 illustrates a system including a terminal and a mobile terminal according to an embodiment of the present invention. Specifically, FIG. 3 illustrates a system 300 including a mobile terminal 301 having a mobile application 310, a memory 330, a display 340, an input unit 350, and a wireless transmitter 320. The mobile terminal 301 includes, for example, a cell phone, a tablet, a Personal Digital Assistant (PDA), and an MP3 player. The input unit 350 includes, for example, at least one of a keyboard and a touch screen. The input unit 350 is used by the student to input the enrollment information into the Internet portal 140. The mobile terminal 301 also includes a mobile processor 360 for transmitting the enrollment information over the Internet connection through the Internet portal 140 to the first terminal A.

The mobile terminal 301 includes the mobile application 310 saved on the memory 330. The wireless transmitter 320 communicates with the first terminal A. Thus, the mobile application 310 provides access, via a wireless Internet connection, to the database 110 through an Internet portal 140. The mobile terminal further includes the display 340 for viewing the enrollment information.

The mobile application 310, i.e., an “App”, allows the student to access the Internet portal 140 using the mobile terminal 301. The mobile application 310 is preferably downloaded from the Internet portal 140. Information is transmitted and received by the mobile terminal 301 via the Internet connection through the wireless transmitter 320 from the first terminal A. The first terminal A is configured as described above with respect to FIG. 1. Thus, the mobile application 310 provides the student with immediate access to the Internet portal 140.

According to an embodiment of the present invention, a method for incentivizing school performance is provided. The method includes receiving enrollment information of a student at a server, such as the first terminal A, and receiving score information input by a first user using an Internet portal 140. According to an embodiment of the present invention, the score information includes at least one of grades and attendance information. The score information may also include participation in athletics or other school-related activities, community volunteer work, etc. The first user, which is authorized to input score information, may be an employee of an educational institution, for example, and is identified by a unique first user identifier. The first user accesses the Internet portal 140 using the unique first user identifier and the score information is added by the first user to a student profile corresponding to the student. The student profile is stored on a database 110 and the database 110 is stored in a memory 105 of the server. A credit adjustment value is calculated and added to the student profile based on the added scores. The credit adjustment value is determined based on the additional score information input by the first user in order to determine a change to the student's existing credit balance in the student profile. The credit adjustment value is added to credits previously added to the student profile to obtain a subtotal of credits. Specifically, if the sub-total has previously added credits, the number of credits is added to the previously added credits in a cumulative manner.

The method includes transmitting the sub-total of credits to a second user in response to a request from a user terminal. The second user may be any entity authorized to view a student's credits and/or overall student profile, such as the student, the student's parents and/or guardians, teachers or other school administrators, and/or the businesses described above such as the car dealership, the clothing retailer, the college and the insurance broker, for example. The number of credits is calculated according to a conversion rate provided by the second user based on the scores.

The method includes storing a unique student identifier and a unique second user identifier corresponding to the student and the second user, respectively, in the database. The sub-total of credits is transmitted in response to the request by the second user upon receipt of the unique second user identifier by the server. The request further includes entering a unique identifier into an Internet portal 140 corresponding to the student and verifying an identity of the student by the server. The unique student identifier and the unique second user identifier verifies the identity of the student and the second user, allowing the student and the second user to access, via an Internet connection, the database 110 through the Internet portal 140. The student views items available for purchase from the second user on a display 130. The student sends the request to transmit the sub-total of credits to the second user enabling the student to purchase the items from the second user using the sub-total of credits.

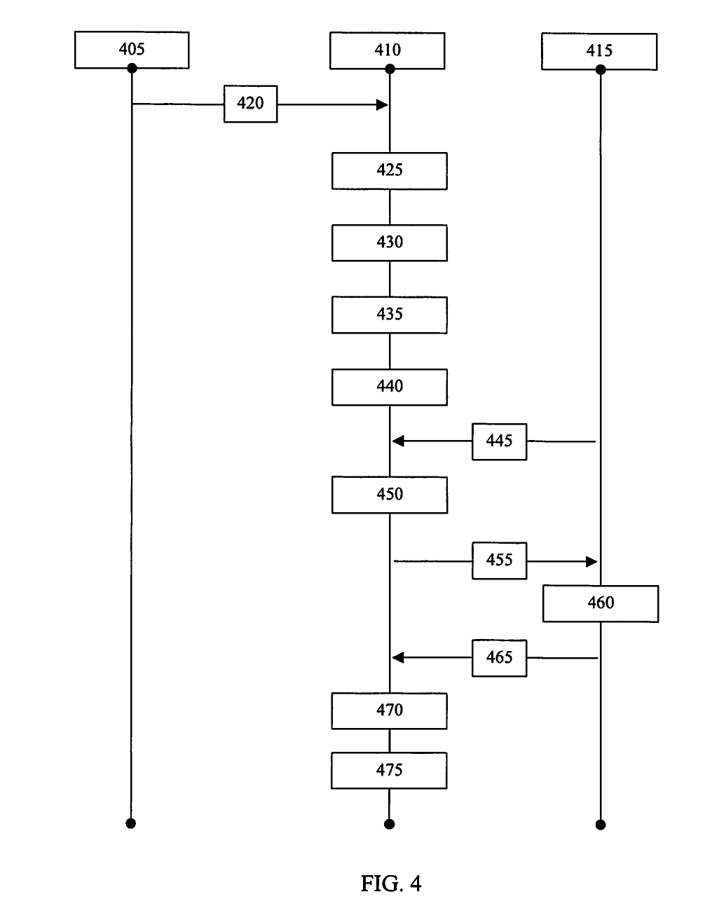

Referring to FIG. 4, FIG. 4 is a flow-chart illustrating a system and method, performed by a server, for incentivizing performance, according to an embodiment of the present invention. Specifically, the method includes receiving score information, by a server 410, corresponding to a performer from a first user terminal 405 in step 420. In step 425, the server 410 adds score information to a profile corresponding to the performer in a database. The score information is input by the performer, who can be a student, subject to verification, as described above. Alternatively, the score information is input by an educational institution enrolled as a contributor. A credit adjustment value is calculated in step 430 based on the received score information and, in step 435, a new total number of credits, i.e. a sub-total of credits, stored in the performer profile is set to a sum of the credit adjustment value and a total number of credits previously stored in the performer profile.

In step 440, merchant offer information is generated by the server 410. The merchant offer information includes items or services available for purchase from a merchant such as a clothing retailer, a college, an insurance broker and a car dealership. Specifically, the items may be available for purchase from the merchant through the Internet portal 140. Alternatively, the items may be purchased from the merchant by selecting a link for the items on the Internet portal 140 to the merchant's website.

In step 445, a request for merchant offer information is transmitted by the second user terminal 415 to the server 410. Upon receiving the request for merchant offer information corresponding to the performer profile, the server 410 generates, in step 450, for at least one merchant, a respective merchant offer according to at least a portion of the total number of credits set in the performer profile and information corresponding to the merchant. In step 455, the server 410 transmits, in response to the request from the second user terminal 415, the at least one generated merchant offer to the second user terminal 415.

In step 460, the second user terminal 415 selects an offer from among the at least one generated merchant offer. In step 465, the server 410 receives from the second user terminal 415, the selection of the offer. The server 410 performs a purchase from the merchant corresponding to the selected merchant offer in step 470. In step 475, the server 410 reduces the total number of credits set in the performer profile by a number of credits corresponding to the selected merchant offer.

According to an embodiment of the present invention, a virtual shopping location is provided with a plurality of virtual stores arranged in a virtual mall, with each merchant occupying a virtual store in the virtual mall. The second user terminal preferably presents the virtual shopping location as a three-dimensional mall within which the performer, preferably represented by an avatar, can travel to browse for goods and services offered at the virtual stores for purchase by the performer.

The goods and services offered at the virtual stores are available for purchase using a predefined number of purchase credits, and the merchant can provide a discount of the predefined number of purchase credits to the performer when an entity related to the performer purchases one of the goods and services of the merchant. In addition, the merchant can increase the discount when the performer is at a location near where the merchant has a physical store, and/or provide that the discount is valid for a limited offer time.

According to an embodiment of the present invention, a method is provided to incentivizing student school performance that includes storing a database on a memory, accessing the database through an Internet portal via an Internet connection, inputting enrollment information of a student into a the student profile accessed through the Internet portal, inputting financial information of the student into a profile accessed through the Internet portal, displaying the enrollment information on a display, inputting at least one of test scores, and attendance and credit card payment data into the student profile, storing the student profile on the database, and adding credits to an account associated with the profile, based on changes to one of the test scores, and attendance and credit card payment data. A unique student identifier and a unique contributor identifier are preferably provided that correspond to the student and the contributor, respectively, with the unique student identifier and a unique contributor identifier being in the database.

The financial information preferably includes student history of payment of invoices to the student and a ratio of current revolving debt of the student to a total available revolving credit or credit limit of the student, for display to the student of the enrollment and financial information.

An educational institution will preferably verify the scores and attendance input into the student profile, with the scores being an aggregate of individual scores, and credits are automatically added to the account upon reaching a predetermined threshold that is based on the scores and attendance that are input into the student profile.

Contributor enrollment information is input into a contributor profile that is accessible via the Internet portal. The contributor can be a parent, business or educational institution that can link the account to a bank account to allow the contributor to add real money to the account. The business can include a car dealership, a clothing retailer, a college and an insurance broker. In addition, credits can be automatically added to the account upon reaching a predetermined threshold, and the credits can be converted into real money based on the contributor's conversion rate.

While the invention has been shown and described with reference to certain embodiments of the present invention thereof, it will be understood by those skilled in the art that various changes in form and details may be made therein without departing from the spirit and scope of the present invention as defined by the appended claims and equivalents thereof.

What is claimed is:

1. A method for incentivizing performance, the method comprising:
receiving score information corresponding to a performer from a first user terminal;
adding the score information to a profile corresponding to the performer in a database;
calculating a credit adjustment value based on the received score information;
setting a new total number of credits stored in the performer profile to a sum of the credit adjustment value and a total number of credits previously stored in the performer profile;
receiving, from a second user terminal, a request for merchant offer information corresponding to the performer profile;
generating, for at least one merchant, a respective merchant offer according to at least a portion of the total number of credits set in the performer profile and information corresponding to the merchant; and
transmitting, in response to the request from the second user terminal, the at least one generated merchant offer.

2. The method of claim 1, further comprising:
receiving, from the second terminal, a selection of an offer from among the at least one generated merchant offer;
performing a purchase from the merchant corresponding to the selected merchant offer, and reducing the total number of credits set in the performer profile by a number of credits corresponding to the selected merchant offer.

3. The method of claim 1, further comprising a virtual shopping location having a plurality of virtual stores arranged in a virtual mall.

4. The method of claim 3, wherein each merchant occupies a virtual store in the virtual mall.

5. The method of claim 4, wherein the second user terminal presents the virtual mall in a three-dimensional presentation for browsing by the performer of one of goods and services offered at the virtual stores for purchase by the performer.

6. The method of claim 5, wherein the goods and services offered at the virtual stores are purchased using a predefined number of purchase credits.

7. The method of claim 6, wherein the merchant provides a discount to the performer when an entity related to the performer purchases one of the goods and services of the merchant.

8. The method of claim 7, wherein the discount is of the predefined number of purchase credits.

9. The method of claim 7, which the discount increases when the performer is at a location near where the merchant has a physical store.

10. The method of claim 9, which the discount is valid for a limited offer time.

11. A method for incentivizing student performance, the method comprising:
storing a database on a memory;
accessing the database through an Internet portal via an Internet connection;
inputting enrollment information of a student into a student profile accessed through the Internet portal;
inputting financial information of the student into the student profile accessed through the Internet portal;
inputting at least one of test scores, attendance and credit card payment data into the student profile;
storing the student profile on the database; and
adding credits to an account associated with the profile, based on changes to one of the test scores, attendance and credit card payment data.

12. The method of claim 11, wherein the financial information includes one of student history of payment of invoices to the student and a ratio of current revolving debt of the student to a total available revolving credit or credit limit of the student.

13. The method of claim 11, further comprising displaying, on a display, the enrollment and financial information.

14. The method of claim 11, wherein a predetermined threshold is set based on one of the scores and attendance input into the student profile.

15. The method of claim 14, further comprising verifying, by an educational institution, the scores and attendance input into the student profile.

16. The method of claim 14, wherein the scores comprise an aggregate of individual scores.

17. The method of claim 13, further comprising inputting enrollment information of a contributor into a contributor profile accessed through the Internet portal, wherein the contributor comprises at least one of a parent, a business, and an educational institution.

18. The method of claim 17, further comprising linking a bank account to the account associated with the profile, to allow the contributor to add real money to the account.

19. The method of claim 17, wherein the business comprises one of a car dealership, a clothing retailer, a college, and an insurance broker.

20. The method of claim 19, further comprising converting the credits to real money based on the contributor's conversion rate.

21. The method of claim 13, further comprising automatically adding the credits to the account associated with the profile upon reaching a predetermined threshold.

22. The method of claim 17, further comprising storing a unique student identifier and a unique contributor identifier corresponding to the student and the contributor, respectively, in the database.
